(19) United States
(12) Patent Application Publication
(10) Pub. No.: US 2005/0068172 A1
(43) Pub. Date: Mar. 31, 2005

(54) Parental alert and child tracking device

(76) Inventor: Deborah L. King, Hazelwood, MO (US)

Correspondence Address: CHARLES C. MCCLOSKEY, 763 S. NEW BALLAS ROAD STE. 170, ST. LOUIS, MO, 63141, US

(21) Appl. No.: 10/672,871

(22) Filed: Sep. 29, 2003

(51) Int. Cl. G08B 1/08

(52) U.S. Cl. 340/539.23; 340/573.4

(57) ABSTRACT

A tracking assembly monitors a transmitter and alerts a user when the transmitter exceeds a certain distance in real time. The assembly has a receiver, transmitter, and a means to secure the transmitter to an object. The receiver has a means to process information, a means to input information, a means to output information, a scanner connected to the processing means, and a power source. Preferably, the input means is keys and buttons; alternatively, a stylus and an entry screen. The transmitter emits a continuously generated radio signal. The securing means affixes the transmitter to skin. In use, the receiver displays the relative location of the transmitter at both short and long ranges.

### BACKGROUND OF THE INVENTION

1. Field of the Invention

The present invention relates to a parental alert and child tracking device for use in connection with tracking children beyond the vision of parents. The parental alert and child tracking device has particular utility in locating children by satellite in real time.

2. Description of the Prior Art

Parental alert and child tracking devices are desirable for watching children when beyond the vision of parents. Devices to monitor the location of children have become increasingly popular to thwart abductions. The devices use radio signals to link a mobile transmitter to a separate receiver. A parent attaches a transmitter to a concealed location on the child. If the child wanders beyond a certain distance, the device notifies the parent who can retrieve the child. If the child wanders greatly beyond a certain distance or endures abduction, the transmitter emits a signal for reception and retransmission by an orbiting satellite. The device then provides the location of the child for rescue. In an interesting application, the receiver tracks multiple transmitters where parents can leave their children in a group for supervision by a staff member such as at a child themed restaurant. The staff member logs the arrival of children and releases them only to pre-designated people.

The use of a personal alarm system is known in the prior art. For example, U.S. Pat. No. 5,289,163 to Perez et al. discloses a child position monitoring and locating device that emits a continuous signal from a transmitter carried by a child to a receiver held by a parent. However, the Perez '163 patent does not accept identifying information about children, and has further drawbacks of no keyboard and no signal transmission to a satellite.

U.S. Pat. No. 4,785,291 to Hawthorne discloses a distance monitor especially for child surveillance that monitors a child at a predetermined range and notifies a parent by sight and sound of the distance to a wandering child. However, the Hawthorne '291 patent does not have a text or graphic display, and additionally does not attach a transmitter to the skin of a child and has no signal transmission to a satellite.

U.S. Pat. No. 5,748,087 to Ingargiola et al. discloses a remote personal security device that monitors children at adjustable ranges and notifies a parent by sight and sound of the distance to a wandering child. In one application, the Ingargiola '087 patent has a transmitter located within the soles of a child's shoes. This application may face heightened scrutiny during airport screening. However, the Ingargiola '087 patent does not have a keyboard for entering information, and additionally does not emit signals to satellites.

Similarly, U.S. Pat. No. 5,650,770 to Schlager et al. discloses a self-locating remote monitoring device that conserves transmitter power by using a polling signal to summon the transmitter's location when the transmitter exceeds a predetermined distance or encounters a hazard. However, the Schlager '770 patent does not have a keyboard in the base station to enter identifying information for the wearer of the transmitter, and cannot monitor multiple remote units.

Similarly, U.S. Pat. No. Des. 391,510 to Leo et al. discloses a combined transmitter and receiver for locating lost children that has a belt mounted transmitter and a receiver with a display of radial distance rings and cardinal directions. However, the Leo D'510 patent does not attach the transmitter to the skin of a child, and cannot enter text and numeric information into the receiver.

Similarly, U.S. Pat. No. 5,771,002 to Creek et al. discloses a tracking system using radio frequency signals that identifies the unique codes of multiple transmitters and reradiates signals to ascertain the distance to a transmitter. However, the Creek '002 patent does not accept text and numeric information into the receiver, and cannot transmit a signal to an orbiting satellite.

Lastly, U.S. Pat. No. 6,363,324 to Hildebrant discloses a vehicle locating system that provides a vehicle location via a global positioning system—GPS—satellite. However, the Hildebrant '324 patent does not accept identifying information about children, and has further drawbacks of no keyboard and no internal power source for the locator unit.

While the above-described devices fulfill their respective, particular objectives and requirements, the aforementioned patents do not describe a parental alert and child tracking device that allows locating children by satellite. The Perez '163 and Creek '002 patents make no provision for transmitting a radio signal to an orbiting satellite. While the Hawthorne '291 and Leo D'510 patents do not provide for attaching a transmitter to skin. The Ingargiola '087 patent lacks a keyboard for entering information. The Schlager '770 patent makes no provision for multiple remote units. And the Hildebrant '324 patent makes no provision for entering identifying information about children.

Therefore, a need exists for a new and improved parental alert and child tracking device that can be used for locating children by satellite. In this regard, the present invention substantially fulfills this need. In this respect, the parental alert and child tracking device according to the present invention substantially departs from the conventional concepts and designs of the prior art, and in doing so provides an apparatus primarily developed for the purpose of locating children by satellite.

### SUMMARY OF THE INVENTION

In view of the foregoing disadvantages inherent in the known types of personal alarm systems now present in the prior art, the present invention provides an improved parental alert and child tracking device, and overcomes the above-mentioned disadvantages and drawbacks of the prior art. As such, the general purpose of the present invention, which will be described subsequently in greater detail, is to provide a new and improved parental alert and child tracking device and method which has all the advantages of the prior art mentioned heretofore and many novel features that result in a parental alert and child tracking device which is not anticipated, rendered obvious, suggested, or even implied by the prior art, either alone or in any combination thereof.

To attain this, the present invention essentially comprises an alert and tracking assembly that tracks the position of a transmitter and alerts a user—typically a parent—when the transmitter—worn by a child—exceeds a certain distance from the user. The assembly has a receiver, transmitter, and a means to secure the transmitter to an object. The receiver has a compact portable housing, a front and a back, a means to process information, a means to input information into the processing means, a means to output information from the processing means to the user, a scanner connected to the processing means, and a power source. Preferably, the input means is keys and buttons on the front of the receiver. Alternatively, the input means is a stylus and an entry screen. The transmitter has a continuously generated radio signal transmitted at a predetermined frequency and at a predetermined strength. The securing means permits affixing the transmitter to skin for at least 21 days. In use, the receiver displays the relative location of the transmitter at both short and long ranges measured by the distance between the transmitter and the receiver.

There has thus been outlined, rather broadly, the more important features of the invention in order that the detailed description thereof that follows may be better understood and in order that the present contribution to the art may be better appreciated.

The invention may also include: buttons to turn the receiver on and off, to scroll through the output means, to choose among the modes of operation, and to activate a search function; a unique code from each transmitter; both local—line of sight—signal reception and GPS satellite signal reception; a microprocessor that receives input, processes information, and displays output; the ability to identify multiple transmitters, measure range and direction to a transmitter; output information by display, alarm light, homing light, sound transducer, vibrating actuator, and port; a waterproof pouch to secure the transmitter to an object—a child; and a cover. Additional features of the invention will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved parental alert and child tracking device that has all of the advantages of the prior art personal alarm systems and none of the disadvantages.

It is another object of the present invention to provide a new and improved parental alert and child tracking device that may be easily and efficiently manufactured and marketed.

An even further object of the present invention is to provide a new and improved parental alert and child tracking device that has a low cost of manufacture with regard to both materials and labor, and which accordingly is then susceptible of low prices of sale to the consuming public, thereby making such parental alert and child tracking device economically available to the buying public.

Still another object of the present invention is to provide a new parental alert and child tracking device that provides in the apparatuses and methods of the prior art some of the advantages thereof, while simultaneously overcoming some of the disadvantages normally associated therewith.

Even still another object of the present invention is to provide a parental alert and child tracking device for locating children by satellite. This allows tracking via satellite children located beyond visual range or earshot from the receiver.

Still yet another object of the present invention is to provide a parental alert and child tracking device for locating children by satellite. This makes it possible to enter identifying information about children into the receiver.

Still yet another object of the present invention is to provide a parental alert and child tracking device for locating children by satellite. This makes it possible to track multiple children with one receiver.

Lastly, it is an object of the present invention to provide a new and improved method of tracking one or more objects using these steps: 1) inserting a transmitter into a pouch; 2) placing the pouch upon the object; 3) entering information about the object into a receiver; 4) activating a receiver to receive a unique signal generated by the transmitter; 5) selecting the mode of operation of the receiver wherein the receiver tracks the signals from one or more objects; and 6) displaying information about the identity and location of the object to the user of the receiver at both short and long ranges between the transmitter and the receiver.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a plan view of the preferred embodiment of the parental alert and child tracking device constructed in accordance with the principles of the present invention.

FIG. 2 is a plan view of an alternate embodiment of the parental alert and child tracking device of the present invention.

FIG. 3 is a rear view of the parental alert and child tracking device of the present invention.

FIG. 4 is a plan view of the transmitter of the parental alert and child tracking device of the present invention.

FIG. 5 is a diagram of the satellite tracking function of the parental alert and child tracking device of the present invention.

The same reference numerals refer to the same parts throughout the various figures.

### DESCRIPTION OF THE PREFERRED EMBODIMENT

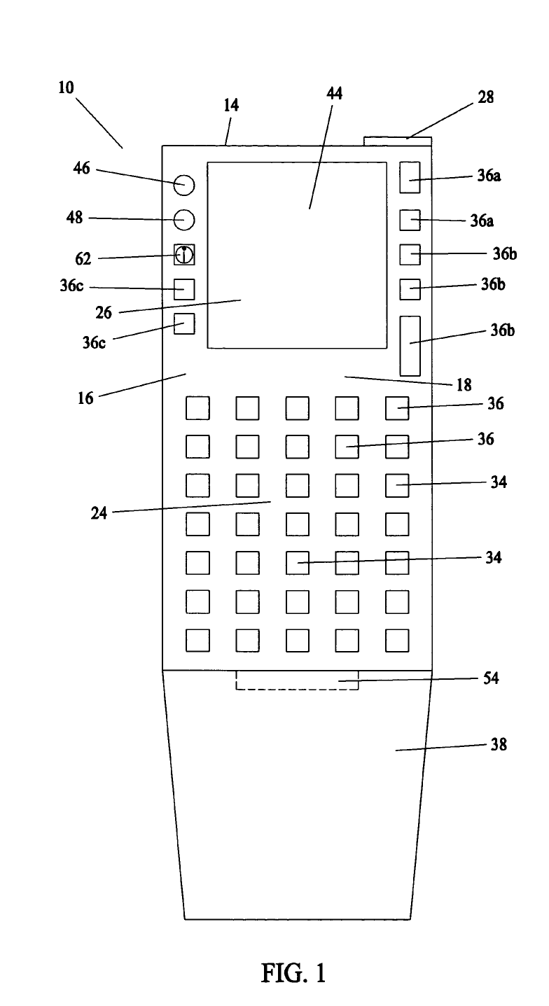

Referring now to the drawings, and particularly to FIGS. 1-5, a preferred embodiment of the parental alert and child tracking device of the present invention is shown and generally designated by the reference numeral 10.

In FIG. 1, a new and improved parental alert and child tracking device 10 of the present invention for locating children by satellite 40 is illustrated and will be described. More particularly, the parental alert and child tracking device 10 has a receiver 14 generally rectangular in shape suitable for handheld operation. The receiver 14 has a housing 16, an input means 24, an output means 26, a scanner 28, and a processing means 22. The housing 16 has a front 18 and an opposite back 20 with the front 18 shown in FIG. 1. The housing 16 is formed from plastic. The input means 24 accepts information from a user about an object to be located. In the preferred embodiment, the input means 24 has an array of keys 34 representing letters and numerals. The key array 34 is similar to a typewriter “QWERTY” arrangement for the letters and has the numerals above the letters closer towards the center of the receiver 14. Opposite the key array 34, the receiver 14 has the output means 26. In the preferred embodiment, a liquid crystal display 44—LCD—serves as the output means 26. The display 44 is generally rectangular and at least half as wide as the lateral axis of the housing 16. Opposite the display 44 and the key array 34, the housing 16 has a scanner 28. The scanner 28 receives radio signals from the transmitter 12 and relayed signals from an orbiting satellite 40. The scanner 28 routes signal information to the processing means 22 for use by the user upon the display 44. The processing means 22 stores information from the input means 24, processes the information with the signal, and reveals a result upon the display 44 for the user.

Further, the input means 24 has buttons 36 to control the operation of the receiver 14. An on/off button 62 regulates power to the receiver 14 from the power source 30. One or more scroll buttons 36a allow a user to advance the display 44 line by line to read entered information. One or more mode buttons 36b allow a user to choose functions of the receiver 14 such as search, scrolling, and preset information. Through a mode button 36b, the user may activate previously stored identifying information from a transmitter 12. This reduces the data entry burden during operation of the receiver 14. For example, a user may select the information from a child #2 out of many stored in the receiver 14. The receiver 14 has an important function to assist a user to find a wayward child wearing a transmitter 12. A search button 36c allows a user to command the receiver 14 to scan the allotted radio frequency band to find a selected transmitter 12. In the search mode, the receiver 14 reveals the direction and distance to the transmitter 12 upon the display 44. If the transmitter 12 exceeds a predetermined distance, the search mode of the receiver 14 queries an orbiting satellite 40 to relay the signal of the transmitter 12 to the receiver 14. As a protective measure, the receiver 14 has a removable cover 38 for the input means 24.

The output means 26 has additional features of an alarm light 46 and a homing light 48 visible upon the front 18 of the housing 16. When the transmitter 12 exceeds a predetermined distance from the receiver 14, the processing means 22 triggers the alarm light 46 to illuminate steadily. An alert user will notice the alarm light 46 and act to recover a wandering child. The predetermined distance may vary based upon the environment of the child. For instance, an open field may provide a greater predetermined distance—typically sight distance of the parent—than a forest—typically earshot of the parent. When the user selects the search mode, the scanner 28 acquires the signal of the transmitter 12 and feeds it to the processing means 22. The processing means 22 reveals the direction and distance to the transmitter 12 upon the display 44. As an alternate to compass and pace readings, the receiver 14 has a homing light 48 to assist the user in finding the direction and closing the distance to the transmitter 12. The homing light 48 blinks intermittently and the blinking frequency increases when the receiver 14 points towards the transmitter 12 and approaches the transmitter 12. As a special feature, the output means 26 includes a port 54 opposite the scanner 28 and the key array 34. The port 54 allows one receiver 14 to share information with a second receiver 14. For example, a child wearing a transmitter 12 may exceed the predetermined distance greatly. A parent may request police assistance. When the police arrive, the parent can download information from the receiver 14 into the police receiver 14 so the police may assist.

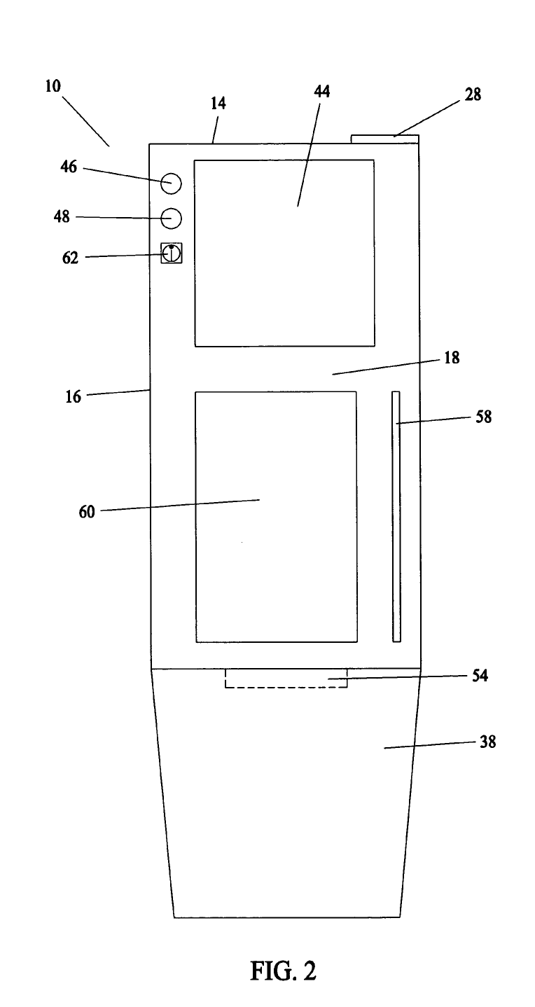

Turning to FIG. 2, an alternate embodiment of the input means 24 and buttons 36 appears. The input means 24 has an entry screen 60, generally rectangular, LCD, and touch sensitive. A stylus 58, generally plastic, enters information upon the entry screen 60 and into the processing means 22 and selects modes of operation of the receiver 14 and display means 44. A user would grasp the stylus 58, tap the entry screen 60, and enter identifying information for a transmitter 12 using the stylus 58. Tapping the entry screen 60 with the stylus 58 again, the user would select the mode of the receiver 14 from scroll, preset information, and search. This embodiment retains an on/off button 62, an alarm light 46, a homing light 48, a display 44, a scanner 28, a cover 38, and a port 54 as in FIG. 1.

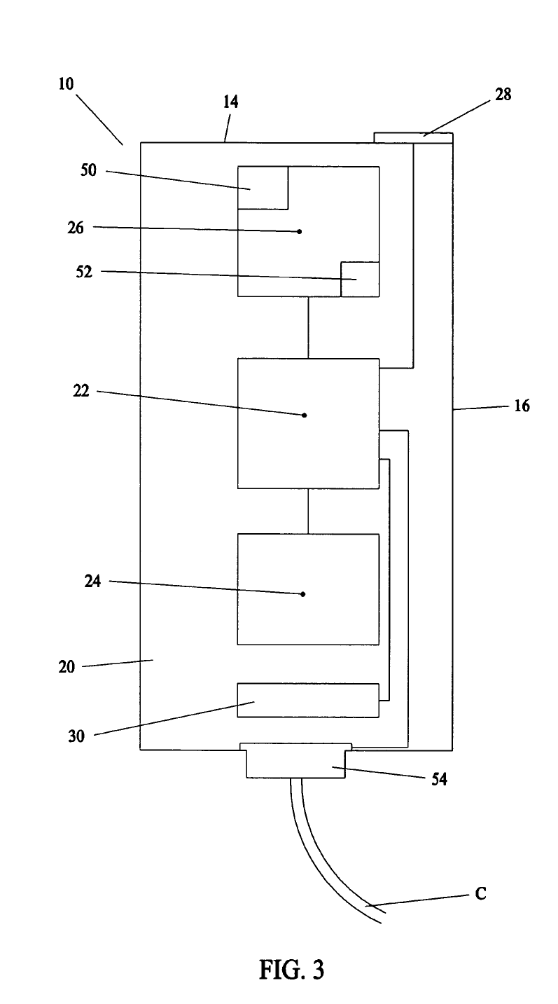

FIG. 3 illustrates the relationship between the input means 24, processing means 22, output means 26, scanner 28, port 54, and power source 30 with the back 20 of the housing 16 removed. The power source 30 energizes the processing means 22 and the remainder of the receiver 14. The power source 30 is a rechargeable battery. The processing means 22 in the form of a microprocessor 42 receives information from the input means 24. The information identifies the transmitters 12 and selects the mode of operation of the microprocessor 42 and hence the receiver 14. Accepting signal information from the scanner 28, the microprocessor 42 processes the signal with the identifying information in the mode selected and sends a result to the output means 26. The output means 26 reveals the result on the display 44, the alarm light 46, and the homing light 48. The output means 26 also activates a transducer 50 to sound loudly when the transmitter 12 exceeds a predetermined distance in conjunction with the alarm light 46. The transducer 50 also sounds intermittently in conjunction with the homing light 48. Then the output means 26 also energizes an actuator 52 to vibrate the housing 16 when the transmitter 12 exceeds a predetermined distance in conjunction with the alarm light 46 and sound transducer 50. As a separate feature, the microprocessor 42 of one receiver 14 can exchange information with a second receiver 14 through the port 54. The microprocessor 42 would exchange the identifying information, direction, and distance of a transmitter 12 to the microprocessor 42 of a second receiver 14 via a cable C. The second receiver 14 could then track the transmitter 12.

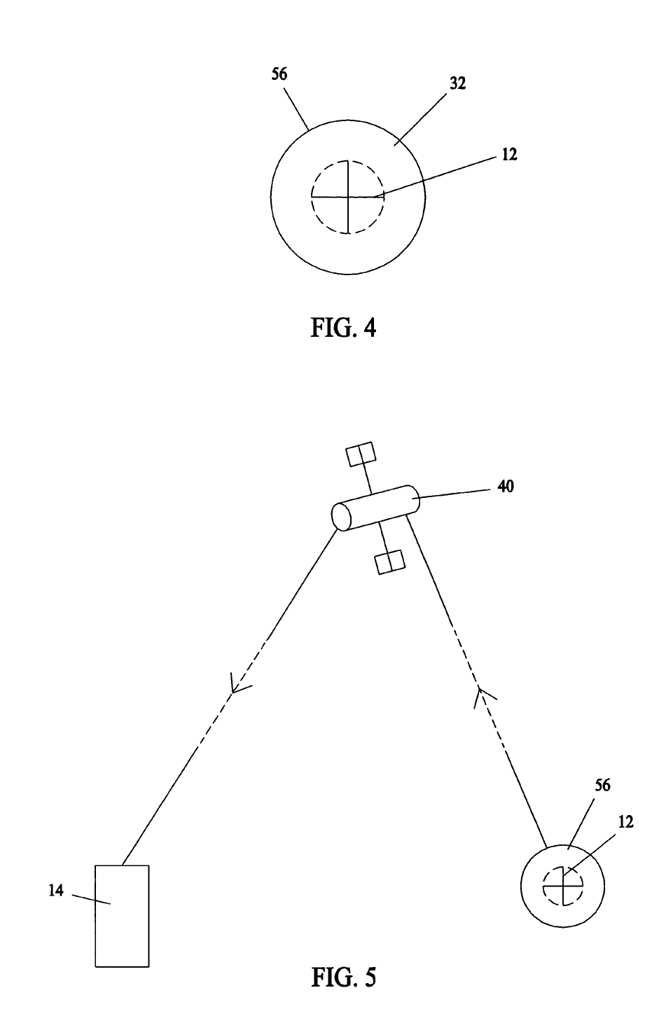

The transmitter 12 appears in FIG. 4. A means to secure 32 the transmitter 12 takes the form of a round plastic pouch 56. The transmitter 12 and its power source 30, typically a battery, fit within a pouch 56. The waterproof pouch 56 surrounds the transmitter 12. The pouch 56 has a generally skin tone color and an adhesive to bond with skin for at least 21 days. A user, typically a parent, places the transmitter 12 within the pouch 56 then places the pouch 56 upon an object, typically a child.

FIG. 5 shows a schematic of the long-range operation of the receiver 14. When the transmitter 12 exceeds a predetermined distance greatly, such as beyond receiver 14 range or from curvature of the earth, an earth orbiting satellite 40 receives the transmitter 12 signal. The satellite 40 relays that signal to the receiver 14 when queried by the receiver 14. The satellite 40 is one of the constellation of GPS satellites 40. The receiver 14 accepts the GPS signal and computes the location of the transmitter 12. The receiver 14 then reveals that location on the display 44. When the receiver 14 nears the location, the homing light 48 activates for the close approach to the transmitter 12.

In use, it can now be understood that a parent places a transmitter 12 within a pouch 56 and the pouch 56 upon a child. The pouch 56 typically adheres to the child's skin in the upper back 20. This prevents the child from dislodging the pouch 56 and conceals the pouch 56 under clothing. The parent then turns on the receiver 14 and enters the child's identifying information by keys 34 or stylus 58 into the input means 24 to correspond with the transmitter signal. The parent selects a predetermined distance and lets the child play. If the child wanders beyond the distance, an alarm sounds, the housing 16 vibrates, and lights illuminate to notify the parent. The parent then uses the receiver 14 to track the child by the direction and distance provided on the display 44 and through the homing light 48 and sound transducer 50. If the child wanders beyond the range of the receiver 14, such as over a hill or when abducted in a car, the signal of the transmitter 12 reaches an orbiting satellite 40. The parent then selects search mode 36c upon the receiver 14 and the receiver 14 queries the GPS satellite 40 for the location of the transmitter 12. If the parent summons police assistance, the parent can exchange location and identifying information with a receiver 14 operated by the police through a cable C between ports 54. The police can then perform a rescue.

Further, institutions that supervise children can use the receiver 14 to track multiple children. A day care center or child themed restaurant may have many children under supervision. When a child enters an institution, the parent provides identifying information to an institution employee who enters the information into a receiver 14. Each receiver 14 can track twenty transmitters 12, usually worn by children. When a child wanders or is taken beyond a distance set by the institution, an alarm sounds on the receiver 14 notifying an institution employee to act.

The transmitter 12 emits a unique numeric code on a continuous signal. While the receiver 14 stores up to and including twenty records containing identifying information. The identifying information includes a child's name and phone number. Upon capturing a signal, the receiver 14 checks the code of the signal against the stored records. When the code matches a record, the receiver 14 displays 44 the identifying information to the user. A user may program the receiver 14 for different environments such as a store, park or yard, or home. For example, the user may set a ten foot predetermined distance when the child goes to a store. In a park setting, the user may increase the predetermined distance to visual range. At home during nighttime, the user may coordinate the predetermined distance with the perimeter of the home. In each of the examples, when the child exceeds the predetermined distance, the receiver 14 activates the output means 26 to alert the user. In the event a child wanders beyond visual range or is late, the user can activate the search mode 36c to determine the location of the child via satellite 40. From the parental alert and child tracking device, users—like parents—have peace of mind from the ability to find a child quickly.

From the software within the receiver 14, the user can select a mode of operation. The preset mode allows a user to enter information and store it. The user can store identifying information for children regularly tracked and predetermined distances for different environments 36b. In scroll mode 36a, the user advances through information stored in the receiver 14. In search mode 36c, the receiver 14 seeks the transmitter signal whether on line of sight or relayed by earth orbiting satellite 40. The user also selects the method of the output means 26, such as the alarm light 46, homing light 48, vibrate, and transducer 50 volume. Sound volume becomes important for nighttime use of the receiver 14. A sleeping user may require a louder volume to alert the user when a child exceeds the predetermined distance.

While a preferred embodiment of the parental alert and child tracking device has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable sturdy material such as metal, composite, or a variety of wood may be used instead of the plastic housing described. Also, the display may be made of light emitting diodes, cathode ray tubes, or similar devices. Although locating children by satellite has been described, it should be appreciated that the parental alert and child tracking device herein described is also suitable for tracking hospital patients, nursing home residents, and livestock. Furthermore, a wide variety of transmitter securing means may be used instead of the skin adhering pouch described.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An alert and tracking assembly for monitoring the position of a transmitter and alerting a user when said transmitter is located beyond a certain distance from said user, said alert and tracking assembly comprising:
a receiver having a compact portable housing, a front and a back, a means to process information, a means to input information into said processing means, a means to output information from said processing means to said user, a scanner connected to said processing means, and a power source;
said transmitter having a continuously generated radio signal transmitted at a predetermined frequency and at a predetermined strength; and,
a means to secure said transmitter whereby, said receiver displays the relative location of said transmitter at both short and long ranges defined by the distance between said transmitter and said receiver.

2. The tracking assembly of claim 1 further comprising:
said input means having keys upon said front corresponding to the alphabet and numerals; buttons upon said front to scroll through said output means, to choose modes of operation for said processing means, and to activate the search modes of said scanner; and,
a removable cover to prevent inadvertent striking of said keys.

3. The tracking assembly of claim 1 wherein said scanner receives the signal directly from said transmitter at short range, and receives the signal when relayed by an earth orbiting satellite from said transmitter at long range.

4. The tracking assembly of claim 1 further comprising:
said processing means having a microprocessor that accepts information from said input means and said scanner, processes the information, and displays the information via said output means.

5. The tracking assembly of claim 4 wherein said microprocessor stores identifying information about multiple transmitters, compares a signal with the identifying information to ascertain said transmitter selected by said input means, determines direction to said transmitter, and measures the strength of said signal.

6. The tracking assembly of claim 5 further comprising:
said output means having upon said front,
a display for presenting information to the user from said microprocessor,
an alarm light controlled by said microprocessor that illuminates when the strength of said signal falls below a predetermined threshold value,
an homing light controlled by said microprocessor that intermittently illuminates and increases illumination in the direction and the proximity of said transmitter,
and having within said housing,
a transducer controlled by said microprocessor that sounds constantly when the strength of said signal falls below a predetermined threshold value and sounds intermittently and more regularly in the direction and the proximity of said transmitter,
an actuator that vibrates said housing in cooperation with said alarm light, and
a port.

7. The tracking assembly of claim 6 wherein said port transfers information from a first receiver to a second receiver.

8. The tracking assembly of claim 7 wherein said port connects to a cable.

9. The tracking assembly of claim 3 wherein said transmitter has a unique code encoded within said signal.

10. The tracking assembly of claim 9 further comprising:
said securing means having a waterproof pouch attached by an adhesive to an object to be located and said transmitter fits within said pouch.

11. A parental alert and child tracking assembly, comprising:
a receiver having a compact portable housing, a front and a back, a means to process information, a means to input information into said processing means, a means to output information from said processing means to a user, a scanner connected to said processing means, and a power source; and,
a transmitter having a radio signal transmitted at a predetermined frequency and at a predetermined strength and a means to secure said transmitter,
whereby, upon said transmitter exceeding a certain distance from said receiver, said assembly displays the location of said transmitter relative to said receiver at both short and long ranges.

12. The tracking assembly of claim 11 further comprising:
said input means having a stylus of slender cylindrical shape, an entry screen suitable for reading strokes of said stylus as letters and numerals, and as selections of operating modes of said receiver, and an on/off button to control power to said receiver.

13. The tracking assembly of claim 11 further comprising:
said processing means having a microprocessor that accepts information from said entry screen and said scanner, processes the information, and displays information via said output means.

14. The tracking assembly of claim 13 wherein said microprocessor stores identifying information about multiple transmitters, compares said signal with the identifying information to ascertain said transmitter of interest selected by the input means, determines direction to said transmitter, and measures the strength of said signal.

15. The tracking assembly of claim 14 further comprising said output means having upon said front,
a display for presenting information to the user from said microprocessor,
an alarm light controlled by said microprocessor that illuminates when the strength of said signal falls below a predetermined threshold value,
an homing light controlled by said microprocessor that intermittently illuminates and increases illumination in the direction and the proximity of said transmitter,
and having within said housing,
a transducer controlled by said microprocessor that sounds constantly when the strength of said signal falls below a predetermined threshold value and sounds intermittently and more regularly in the direction and the proximity of said transmitter,
an actuator that vibrates said housing in cooperation with said alarm light, and
a port that exchanges information from a first receiver to a second receiver.

16. The tracking assembly of claim 15 wherein said port accepts a cable.

17. The tracking assembly of claim 11 wherein said scanner receives the signal directly from said transmitter at short range, and when relayed by an earth orbiting satellite from said transmitter at long range.

18. The tracking assembly of claim 17 said transmitter has a unique code encoded within said signal.

19. The tracking assembly of claim 17 further comprising:
said securing means having a waterproof pouch attached by an adhesive and said transmitter fits within said pouch, and,
a removable cover upon said front to prevent inadvertent striking of said display and said entry screen.

20. A method of tracking one or more objects, the steps comprising:
inserting a transmitter into a pouch; and,
placing said pouch upon said object; and,
entering information about said object into a receiver; and,
activating a receiver to receive a unique signal generated by said transmitter; and,
selecting the mode of operation of said receiver wherein said receiver tracks the signals from one or more objects; and,
displaying information about the identity and location of said object to the user of said receiver at both short and long ranges between said transmitter and said receiver.
